(19) United States
(12) Patent Application Publication
(10) Pub. No.: US 2011/0163878 A1
(43) Pub. Date: Jul. 7, 2011

(54) CAPACITIVE OCCUPANT DETECTION SYSTEM HAVING AGING COMPENSATION AND METHOD

(76) Inventors: Charles A. Gray, Noblesville, IN (US); Kevin D. Kincaid, Kokomo, IN (US); Royce L. Rennaker, Converse, IN (US)

(21) Appl. No.: 12/683,529

(22) Filed: Jan. 7, 2010

(51) Int. Cl. G08B 13/26

(52) U.S. Cl. 340/562

(57) ABSTRACT

An occupant detection system and method are provided. The system includes a capacitive sensor having an electrode arranged in a seat proximate to an expected location of an occupant for sensing an occupant presence approximate thereto. The capacitive sensor is configured to provide an output indicative of the sensed occupant presence. Occupant detection circuitry processes the sensor output and determines an aging compensation value to compensate for aging characteristics of the seat. The occupant detection circuitry detects a state of occupancy based on the sensor output and the aging compensation value.

### TECHNICAL FIELD

The present invention generally relates to occupant sensing systems, and more particularly relates to a system and method for detecting an occupant on a vehicle seat that includes an electrode configured to have a resonate frequency that is dependent on presence of an occupant.

### BACKGROUND OF THE INVENTION

Automotive vehicles are commonly equipped with air bags and other devices that are selectively enabled or disabled based upon a determination of the presence of an occupant in a vehicle seat. It has been proposed to place electrically conductive material in a vehicle seat to serve as an electrode for detecting the presence of an occupant in the seat. For example, U.S. Patent Application Publication No. 2009/0267622 A1, which is hereby incorporated herein by reference, describes an occupant detector for a vehicle seat assembly that includes an occupant sensing circuit that measures the impedance of an electric field generated by applying an electric signal to the electrode in the seat. The presence of an occupant affects the electric field impedance about the electrode that is measured by the occupant sensing circuit.

As the vehicle seat ages with time and usage, the baseline capacitance of the seat often changes, typically by increasing in capacitance. This change in the baseline or empty seat capacitance also affects the capacitance sensed when an occupant is seated in the seat. The change in capacitance may be due to a combination of factors including changes in electrical characteristics of the sensor, including the electrode sensor mat and electronics associated therewith, migration of foreign substances through the seat trim to the sensor mat, multiple wet/dry cycles in the seat, changes in the electrical characteristics of the seat itself caused by time and usage, and other causes.

It would be desirable to provide for accurate sensing of occupancy of a seat using an electrode configured to have a resonate frequency that is less susceptible to changes in electrical characteristics of the seat and/or sensor as the seat ages.

### SUMMARY OF THE INVENTION

According to one aspect of the present invention, an occupant detection system is provided. The system includes a capacitive sensor comprising an electrode arranged in a seat proximate to an expected location of an occupant for sensing an occupant presence proximate thereto. The capacitive sensor is configured to provide an output indicative of the sensed occupant presence. The system further includes occupant detection circuitry for processing the capacitive sensor output and for further determining an aging compensation value to compensate for aging characteristics of the seat. The occupant detection circuit detects a state of occupancy of the seat based on the capacitive sensor output and the aging compensation value.

According to another aspect of the present invention, a method of detecting an occupant in a seat is provided. The method includes applying an alternating current signal to an electrode arranged in a seat proximate to an expected location of an occupant for generating an electric field at the expected location, detecting a voltage response to the electric field, and generating a first output based on the voltage response indicative of a characteristic of an occupant. The method further includes the steps of determining an aging characteristic of the seat, generating an aging compensation value indicative of the aging characteristic, and processing the first output to detect a state of occupancy of the seat based on the first output and the aging compensation value.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a partial exploded perspective view of a seat assembly incorporating an occupant detection system, according to one embodiment;

FIG. 2 is a block/circuit diagram of the occupant detection system, according to one embodiment;

FIGS. 3A and 3B is a flow diagram illustrating a routine for sensing occupancy of a seat based on capacitive sensing;

FIG. 4 is a flow diagram for classifying an occupant based on the capacitive sensing;

FIG. 5 is a flow diagram illustrating a routine for performing aging compensation updates, according to one embodiment; and

FIG. 6 is a flow diagram illustrating a routine for performing aging compensation adjustments, according to one embodiment.

### DESCRIPTION OF THE PREFERRED EMBODIMENTS

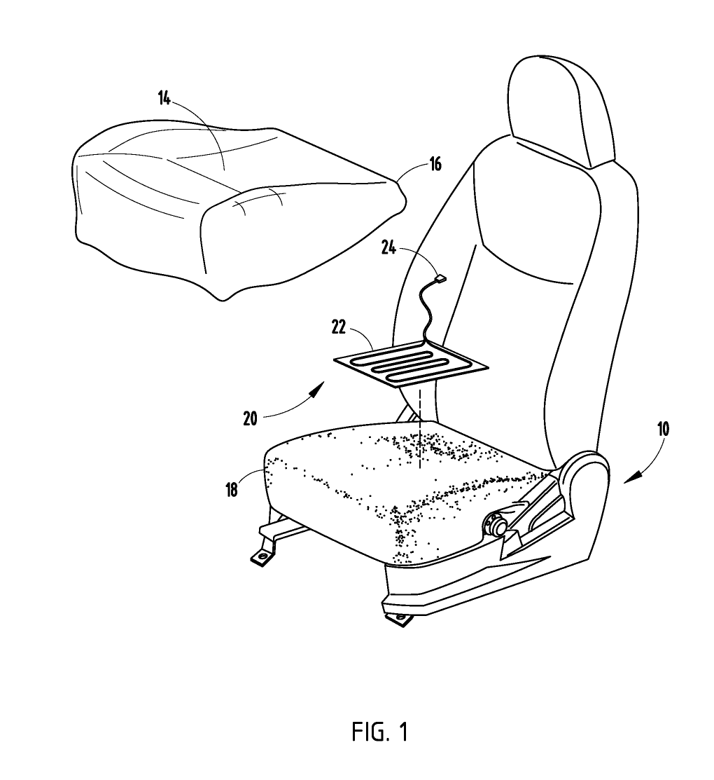

Referring now to FIG. 1, an exemplary automotive vehicle seat assembly 10 is generally shown having a top side seating surface 14 suitable for supporting an occupant (not shown). The seat assembly 10 is adapted to be installed in a vehicle passenger compartment, such as a car seat, according to one embodiment, but could be used in any kind of vehicle, such as an airplane, according to another embodiment. The seat assembly 10 has a foam cushion 18 and an overlaying outer covering 16, and a capacitive sensing electrode 22 installed in the seat assembly 10 on or proximate to the top side seating surface 14. In the embodiment shown, the electrode 22 may be installed on top of the foam cushion 18 and below the outer covering 16, generally near the top surface of the seat which is referred to as the A-surface. The electrode 22 effectively serves as an antenna or capacitive sensor to detect occupancy of the seat 10. The electrode 22 may be formed of suitable materials that allow for electrical conductivity for the electrode 22 to receive a signal and generate a voltage output that may include metal wire, conductive fiber, metal foil, metal ribbon, conductive ink and other conductive materials formed in the shape of a mat or other shape. The vehicle seat assembly 10 includes an occupant detection system 20 which utilizes the capacitive based electrode 22 for sensing occupancy of the seat assembly 10. The occupant detection system 20 further determines an aging compensation value and compensates for aging of the seat to provide for accurate sensing of an occupant, despite changes that may occur to the seat assembly 10 and/or sensor over time.

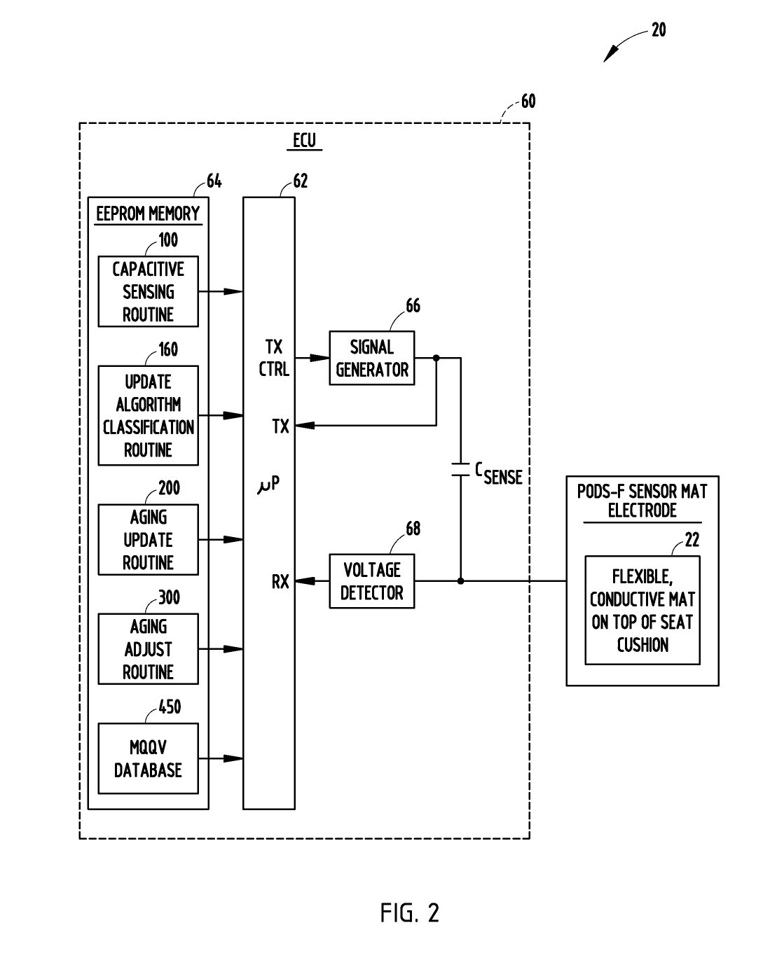

The occupant detection system 20 is illustrated in FIG. 2, according to one embodiment. The occupant detection system 20 includes occupant detection circuitry shown implemented as an electronic control unit (ECU) 60 in communication with the capacitive based electrode 22. The ECU 60 is shown including a microprocessor 62 and memory 64. Memory 64 may include electrically erasable programmable read-only memory (EEPROM) or other volatile or non-volatile memory. Stored in memory 64 is a capacitive sensing routine 100, an update algorithm classification routine 160, an aging compensation update routine 200 and an aging compensation adjust routine 300. Memory 64 also stores minimum qualified Q_{X} (MQQV) values and aging compensation values for ignition cycles in database 400. The routines 100, 160, 200 and 300 may be executed by the microprocessor 62. It should be appreciated that other control circuitry may be employed to process the various routines and provide outputs as described herein.

The ECU 60 is also shown having a signal generator 66 and a voltage detector 68. The signal generator 66 is configured to output a plurality of alternating current (AC) signals at different frequencies. This may include generating a first sine wave signal at a first frequency during a first time period and a second sine wave signal at a second frequency during a second time period. A total of n AC signals at n frequencies may be generated. The plurality of n signals may be output simultaneously or sequentially by the signal generator 66 and applied to the electrode 22 to generate an electric field proximate to the top side seat surface 14.

The signal generator 66 is configured to generate an electric field projected to a location at which an object (occupant) is to be detected, such as the top side seating surface 14 of the seat assembly 10. The impedance of a load affects the voltage response received by the voltage detector 68. The voltage detector 68 measures a voltage for each of the n frequencies at the n time periods. The measured voltages may depend upon the impedance of the load which may include impedance caused by an occupant and environmental conditions such as humidity, moisture and temperature.

It should be appreciated that the microprocessor 62 may include a plurality of noise filters (not shown) and may convert the measured voltages into digital voltage amplitudes. The voltage amplitudes may be compared to determine if a change in voltage has occurred amongst the plurality of frequencies. A change or difference in voltages may be indicative of the presence of an environmental condition that will affect the impedance of a load. One embodiment of the electric field generation and processing of the detected voltages is disclosed in U.S. Patent Application Publication No. 2009/0267622 A1, which is hereby incorporated herein by reference.

The occupant detection system 20 advantageously processes the capacitive based sensor output and determines occupancy of the vehicle seat. The output of the occupant detection system 20 may be used to enable, disable or change the response of a vehicle air bag system or other vehicle systems. In some applications, deployment of an air bag may be enabled when a person or object of a specific size or shape is seated in the vehicle. The size of a person may be proportional to the person's impedance and will affect the voltage sensed by the electrode 22. Additionally, environmental conditions may affect the loading on the system, particularly the electrode 22. The electrode 22 may be compensated to actively control the deployment system by compensating for the detected environmental conditions.

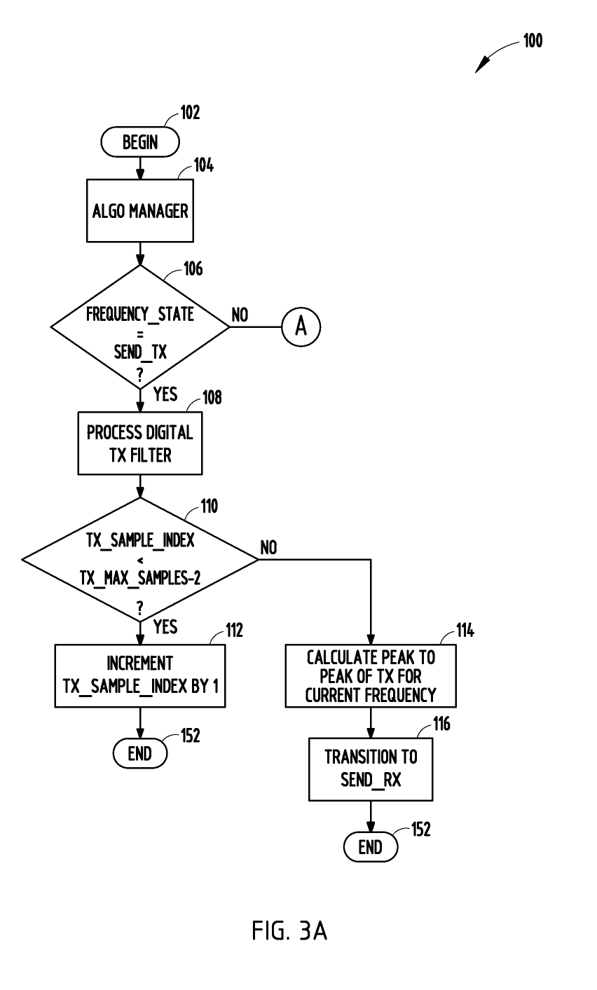

Referring to FIGS. 3A and 3B, a capacitive sensing routine 100 is illustrated according to one embodiment. Routine 100 begins at step 102 and proceeds to step 104 to call the algorithm manager, which may occur at a rate of 120 microseconds, according to one example. Next, at decision step 106, routine 100 determines if the frequency state is set equal to the send TX signal such that the AC transmit signal is being transmitted and, if so, processes the digital transmit filter at step 108. At decision step 110, routine 100 determines if the transmit sample index is less than the maximum transmit samples minus two, such that the requisite number of four frequency signals have completed their transmission. If the transmission of four frequency signals is not complete, routine 100 proceeds to increment the TX_Sample index by one in step 112 and ends at step 152. If the transmit signals are done transmitting at the requisite four frequencies, routine 100 proceeds to step 114 to calculate the peak-to-peak amplitude of the transmit signal for the current frequency to get a measurement of the amplitude, and then proceeds to step 116 to transition to the send RX receive signal. Accordingly, routine 100 transmits signals at four separate frequencies. According to one embodiment, three of the frequencies are high frequencies generally in a range near about 140 megahertz, and the one low frequency signal is generally in a range near about 2 megahertz.

Returning back to step 106, if routine 100 determines that the frequency state is not in the transmit mode, routine 100 proceeds to step 118 to process the digital received RX filter. According to one embodiment, the RX filter uses a 1040 tap filter for the low frequency, and an 80 tap filter for the high frequencies. Next, routine 100 proceeds to decision step 120 to determine if the received RX sample_index is less than the received sample maximum minus two so as to determine whether or not RX signals have been received at all four frequencies. If the RX signals have not been received at all four frequencies, routine 100 proceeds to step 122 to increment the RX sample_index by one, and then determines in decision step 124 if the RX sample_index is within the gain sampling range and, if so, calculates a gain total at step 126. Otherwise, routine 100 ends at step 122. If the received signal has been received for all four frequencies, routine 100 proceeds to step 128 to calculate the peak-to-peak amplitude of the received RX signal for the current frequency. Next, at step 130, routine 100 performs a gain adjust to adjust the gain of the amplifier in the waveform generator to keep the average signal amplitude substantially constant. This may be achieved with a feedback loop to compensate for environmental effects, such as humidity. At step 132, routine 100 adjusts the ECU to calculate the Q_{X} raw value, which normalizes for variations in the ECU synthesizer chip, such that the output remains substantially stable. At decision step 134, routine 100 determines if the table index is equal to zero and, if not, ends at step 152. If the table index is set equal to zero, routine 100 proceeds to step 136 to calculate a noise flag and then proceeds to decision step 138 to determine if the table_index is less than the number of frequencies in the table minus one, which essentially checks for noise on each individual frequency signal. If the decision in step 138 is determined to be yes, routine 100 proceeds to step 140 to increment the table index by one. Otherwise, the update algorithm classification flag is set at step 142. At decision step 144, routine 100 determines if the table_index is equal to the high frequency and, if so, sets the low select to low at step 146 before transitioning to the send TX signal at step 150 and ending at 152. Otherwise, the low select signal is set to high at step 148 before transitioning to the send TX signal at step 150.

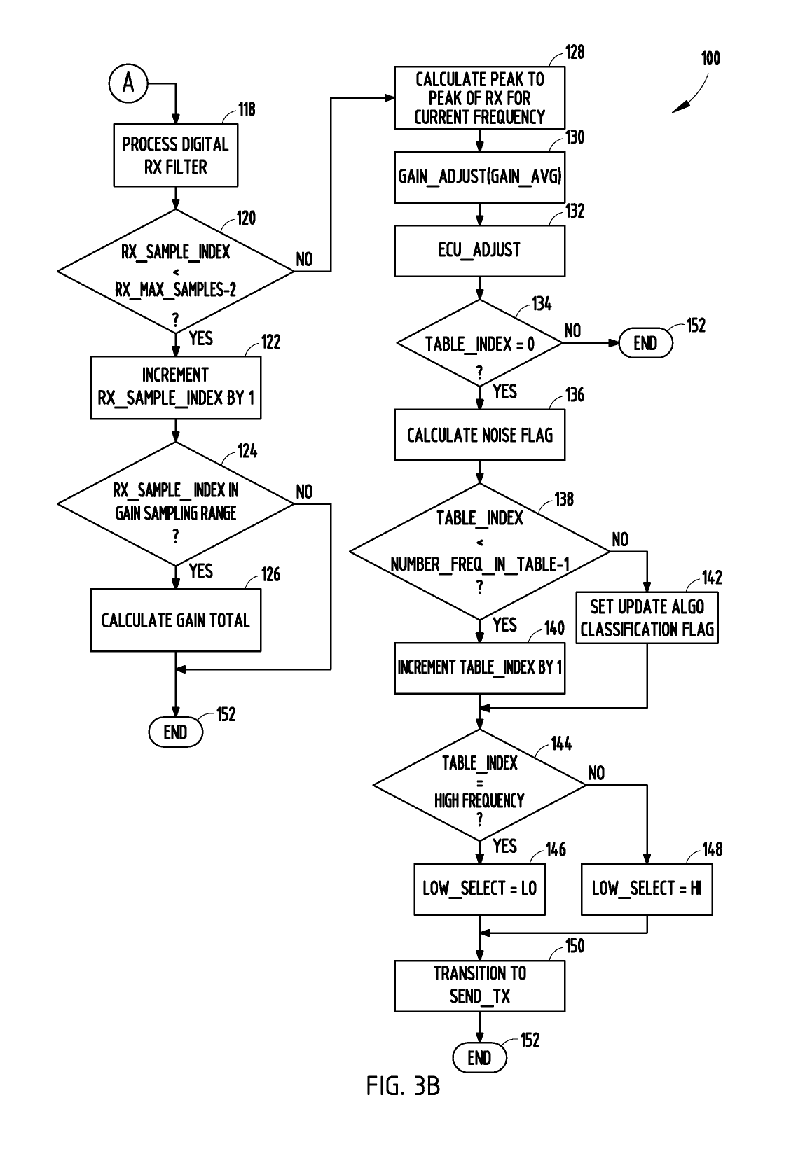

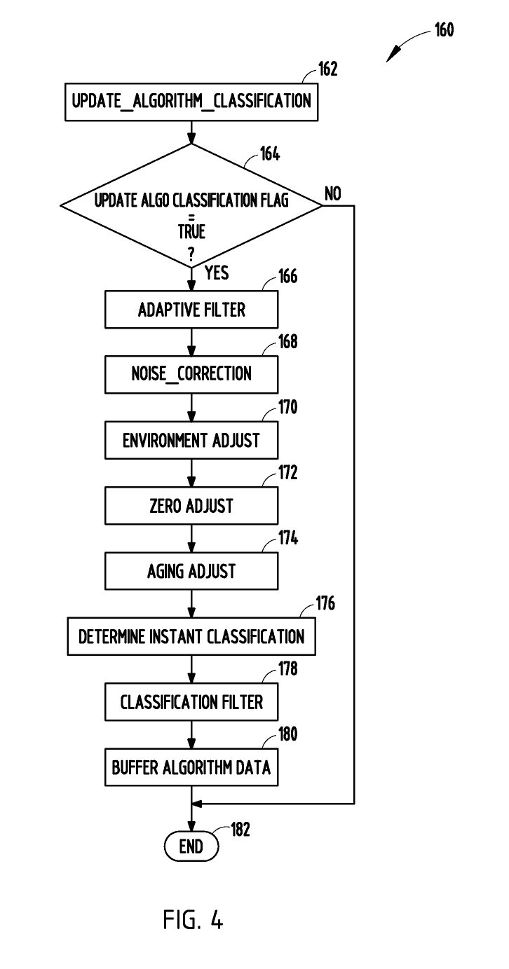

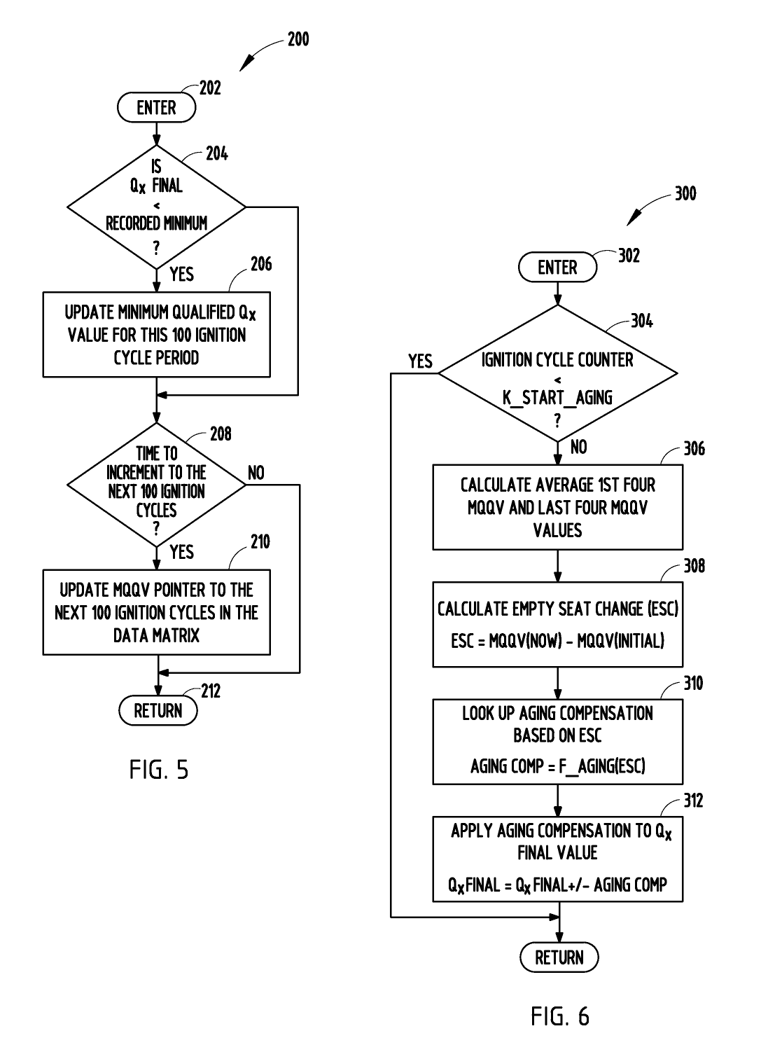

Referring to FIG. 4, an update algorithm classification routine for classifying the capacitive sensed occupant is illustrated as generally indicated by identifier 160. Routine 160 begins the update algorithm classification at step 162, and proceeds to decision step 164 to determine whether the update algorithm classification flag is set equal to true (e.g., binary 1), and if not, ends at step 182. If the update algorithm classification flag is set equal to true, then routine 160 proceeds to step 166 to perform adaptive filtering and then to step 168 to provide noise correction. Next, routine 160 proceeds to the environmental adjust step 170 to compensate for environmental conditions, such as humidity. Next, a zero adjusts step is performed at step 172 in which the capacitive value for an empty seat may be adjusted so as to normalize the seat setting, which may occur at the vehicle assembly facility, according to the automotive application. At step 174, routine 160 periodically provides aging compensation adjust routines 200 and 300 as shown in FIGS. 5 and 6 to adjust for variations in values caused by characteristic changes of the seat and/or sensor during aging of the seat over time and usage. At step 176, routine 160 may determine an instant classification which may be achieved by comparing the median Q_{X} value against a threshold value. At step 178, routine 160 may perform a classification filter which may look for a plurality of comparisons to obtain consecutive Q_{X} middle values exceeding a threshold value. It should be appreciated that Q_{X} is the approximate measure of capacitance and that four Q_{X} values may be obtained, corresponding to the three high frequencies and the fourth low frequency. The median peak-to-peak amplitude value of the three high frequency Q_{X} values may be used to determine whether or not to classify an occupant as an adult. The difference between the low and the high Q_{X} values may be used to adjust for humidity. Q_{X} may be defined in one embodiment by the following equation:

$${Q}_{X} = \frac{{R}_{X} - {T}_{X}}{{T}_{X}} \cdot sense capacitor value ,$$

wherein Q_{X} is approximately one count per picofarad. At step 180, routine 160 may perform a buffer algorithm to buffer the data, before ending at step 182. Accordingly, it should be appreciated that the routines 100 and 160 advantageously provide for an output signal indicative of an occupant and the classification of the occupant based on the capacitive sensing.

The occupant detection system 20 advantageously compensates for aging effects to the seat and the sensor that may occur over time. The detection system 20 employs the aging compensation update routine 200 to periodically update the minimum qualified Q_{X} value. Additionally, occupant detection system 20 includes an aging compensation adjust routine 300 to apply an aging compensation to the occupancy detection so as to compensate of the aging related changes.

The aging compensation update routine 200 is illustrated in FIG. 5, according to one embodiment. Routine 200 begins at step 202 and proceeds to decision step 204 to determine if the Q_{X} final or highest value is less than a recorded minimum value and, if so, proceeds to step 206 to update the minimum qualified Q_{X} value (MQQV) for the current group of one hundred (100) ignition cycles. Otherwise, routine 200 proceeds to step 208. At decision step 208, routine 200 determines if it is time to increment to the next one group hundred (100) ignition cycles and, if so, proceeds to step 210 to update the MQQV pointer to the next one hundred (100) ignition cycles in the data matrix. Otherwise, routine 200 returns at step 212. Accordingly, the minimum qualified MQQV value is updated every one hundred (100) vehicle ignition cycles. In the embodiment shown, vehicle ignition cycles are used as the periodic indicator of seat each, where an ignition cycle may be determined to occur each time the vehicle engine is started. It should be appreciated that other periodic indicators of aging may be employed according to other embodiments.

The aging compensation adjust routine 300 is illustrated in FIG. 6, according to one embodiment. Routine 300 begins at step 302 and proceeds to decision step 304 to determine if the vehicle ignition cycle counter is less than K_start_aging, which is the threshold value generally indicative of the vehicle seat initially considered for aging purposes which may be five hundred (500) ignition cycles of the vehicle, according to one example. If the ignition cycle counter has not reached the K_start_aging threshold, routine 300 begins at step 314. Once the ignition cycle counter reaches the K_start_aging threshold, routine 300 proceeds to step 306 to calculate an average first four MQQV values and last four MQQV values. The first four MQQV values represent the MQQV values for a relatively new (unused) seat. The last four MQQV values represent the minimum qualified Q_{X} values currently measured subsequent to the seat being new. Next, at step 308, routine 300 calculates the empty seat change (ESC) value which is shown as the difference between the current MQQV value currently measured and the new MQQV value initially measured as new. Routine 300 then proceeds to step 310 to lookup the aging compensation value based on the empty seat change value. The aging compensation value may be acquired from a lookup table stored in memory, or may be otherwise calculated. At step 312, routine 300 proceeds to apply the aging compensation value to the Q_{X} final value. This may include adding or subtracting the aging compensation value to or from the Q_{X} final value, according to one embodiment. Finally, routine 300 ends at step 314.

The minimum qualified Q_{X} value is the primary parameter used to sense changes in characteristics of the seat assembly and sensor due to aging, according to one embodiment. For a minimum qualified Q_{X} value to be qualified, the occupant detection system 20 may require that there are no system faults present and little or no noise detected on the frequencies used for the MQQV determination. It should be appreciated that the presence of liquid in or on the seat or extremely high environmental humidity may disqualify a Q_{X} value, because such environmental effects tend to increase the Q_{X} values and thereby may be directionally incorrect for the establishment of a new minimum Q_{X} value.

The minimum qualified Q_{X} value is periodically determined over an aging or usage period of one hundred (100) vehicle engine ignition cycles, according to one embodiment. The MQQV value represents the lowest empty seat capacitance value measured in the seat over the corresponding usage period of one hundred (100) ignition cycles. The MQQV values for each usage period are stored into the MQQV storage matrix or database in memory which may have non-volatile memory locations allocated for lifetime storage. At the beginning of each new one hundred (100) ignition cycle usage period, such as for example, on ignition cycles 101, 201, 301, etc., the MQQV value may be initialized to 1024 to force an establishment of a new MQQV value for the new ignition cycle usage period or range.

The minimum qualified Q_{X} values (MQQVs) may be stored in a non-volatile memory matrix or database with each entry representing the value for one usage range of one hundred (100) ignition cycles of vehicle life. The MQQV stored matrix or database may be programmed to all “1s” in the ECU manufacturing process, which facilitates the establishment of new minimum values and provides a real-time record of where the valid data in the matrix ends. Each one hundred (100) ignition cycle usage range may have an MQQV value stored which corresponds to the given range. One example of an MQQV storage matrix is shown in Table I as follows:

TABLE I

| Ignition Cycle Counter Range | MQQV |
|---|---|
| 1-100 | 220 |
| 101-200 | 223 |
| 201-300 | 224 |
| 301-400 | 226 |
| 401-500 | 227 |
| - - - | - - - |
| 9701-9800 | 254 |
| 9801-9900 | 254 |
| Last 100 Ignition Cycles | 254 |

In one embodiment, the aging compensation determination begins after the vehicle has been sufficiently used, such as after the first five hundred (500) vehicle engine ignition cycles. Accordingly, beginning with the five hundred and one (501) ignition cycle, according to one example, the aging compensation may be applied by determining an empty shift value and then using the empty shift value as an input into one of two aging compensation tables: one table for positive empty shift and another table for negative empty shift. According to one embodiment, the empty shift value may be calculated as follows: Empty Shift=Average of four most recent MQQVs−average of the first four MQQVs.

If the empty shift value is a negative number, the aging compensation adjustment may be determined using a negative aging adjustment lookup table. If the empty shift value is a positive number, the aging compensation adjustment may be determined using a positive aging adjustment lookup table. Examples of Negative and Positive Aging Adjustment Lookup Tables are shown below as Table II and Table III, respectively:

TABLE II

| Empty Shift Value | Aging Compensation Value |
|---|---|
| 0 | 0 |
| −8 | −4 |
| −16 | −8 |
| −24 | −12 |
| −32 | −16 |
| −40 | −20 |
| −48 | −24 |
| −56 | −28 |
| −64 | −32 |

TABLE III

| Empty Shift Value | Aging Compensation Value |
|---|---|
| 0 | 0 |
| +8 | +2 |
| +16 | +4 |
| +24 | +6 |
| +32 | +8 |
| +40 | +10 |
| +48 | +12 |
| +56 | +14 |
| +64 | +16 |

The aging compensation adjustment derived from the relevant positive or negative aging adjustment lookup table above is then compared and limited to a minimum and maximum aging compensation value (K_aging_minimum and K_aging_maximum) before being added to or subtracted from the classification threshold value, according to one embodiment.

Accordingly, the occupant detection system 20 advantageously compensates for aging effects that may occur in the seat assembly 10 and the sensor, such as changes in the baseline capacitance of the seat. Thus, changes due to various factors including changes in the electrical characteristics of the sensor mat and controls, migration of foreign substances through the seat trim to the sensor mat, multiple wet/dry cycles in the seat, and changes in the electrical characteristics of the seat itself, caused by time or usage may be taken into consideration and compensated to provide for accurate occupant detection and occupant classification.

It will be understood by those who practice the invention and those skilled in the art, that various modifications and improvements may be made to the invention without departing from the spirit of the disclosed concept. The scope of protection afforded is to be determined by the claims and by the breadth of interpretation allowed by law.

1. An occupant detection system comprising:
a capacitive sensor comprising an electrode arranged in a seat proximate to an expected location of an occupant for sensing an occupant presence proximate thereto, said capacitive sensor configured to provide an output indicative of the sensed occupant presence; and
occupant detection circuitry for processing the capacitive sensor output and for further determining an aging compensation value to compensate for one or more aging characteristics of the seat, wherein the occupant detection circuitry detects a state of occupancy of the seat based on the capacitive sensor output and the aging compensation value.

2. The occupant detection system as defined in claim 1, wherein the occupant detection circuitry determines a minimum empty seat capacitive related value during a usage period and determines the aging compensation value based on the minimum empty seat capacitance related value.

3. The occupant detection system as defined in claim 2, wherein the occupant detection circuitry compares the minimum empty seat capacitance related value to an initial empty seat capacitance related value and determines the aging compensation value as a function of a difference in the minimum empty seat capacitance related value and the initial empty seat capacitance related value.

4. The occupant detection system as defined in claim 1, wherein the seat comprises a vehicle seat.

5. The occupant detection system as defined in claim 4, wherein the usage period comprises a predetermined number of engine cycles of a vehicle.

6. The occupant detection system as defined in claim 1, wherein the occupant detection circuitry classifies the occupant as one of an adult and a child.

7. The occupant detection system as defined in claim 1, wherein the capacitive sensor comprises an electrically conductive mat provided in the seat.

8. The occupant detection system as defined in claim 1, wherein the capacitive sensor comprises a signal generator for applying an alternating current signal to the electrode and a voltage detector for receiving a voltage signal, wherein the voltage signal is compared to a voltage threshold to generate the output.

9. The occupant detection system as defined in claim 1, wherein the occupant detection circuitry periodically updates the aging compensation value.

10. A method of detecting an occupant in a seat, said method comprising the steps of:
applying an alternating current signal to an electrode arranged in a seat proximate to an expected location of an occupant for generating an electric field at the expected location;
detecting a voltage response to the electric field;
generating a first output based on the voltage response indicative of a characteristic of an occupant;
determining an aging characteristic of the seat;
generating an aging compensation value indicative of the aging characteristic; and
detecting a state of occupancy of the seat based on the first output and the aging compensation value.

11. A method as defined in claim 10 further comprising the step of determining a minimum empty seat capacitive related value during a use period, and the step of generating the aging compensation value comprises determining the aging compensation value based on the minimum empty seat capacitance related value.

12. The method as defined in claim 11 further comprising the step of comparing the minimum empty seat capacitance related value to an initial empty seat capacitance related value and the step of generating the aging compensation value comprises generally the aging compensation as a function of a difference in the minimum empty seat capacitance related value and the initial empty seat capacitance related value.

13. A method as defined in claim 10, wherein the seat comprises a vehicle seat.

14. The method as defined in claim 13, wherein the compensation value is periodically determined based on a usage period which comprises a predetermined number of engine cycles of a vehicle.

15. The method as defined in claim 10 further comprising the step of determining whether the occupant is one of an adult and child.

16. The method as defined in claim 10, wherein the electrode provides capacitive sensing.

17. The method as defined in claim 16, wherein the first output is generated based on a capacitive threshold.

18. The method as defined in claim 10, wherein the aging compensation value is periodically updated.
